(19) United States
(12) Patent Application Publication
(10) Pub. No.: US 2016/0102870 A1
(43) Pub. Date: Apr. 14, 2016

(54) Cooking Pan

(71) Applicant: Neil Timmins, Cumming, IA (US)

(72) Inventor: Neil Timmins, Cumming, IA (US)

(21) Appl. No.: 14/512,034

(22) Filed: Oct. 10, 2014

(51) Int. Cl. F24C 15/14; A21D 8/06

(52) U.S. Cl. CPC F24C 15/14; A21D 8/06

(57) ABSTRACT

Disclosed are methods for cooking a food, for example, pizza. The methods include placing a food item on an inclined surface so that grease generated during the cooking process may flow into a receptacle. A result of the method is a food having reduced grease when compared to a same food item cooked in a conventional manner. Disclosed also are devices that may be used to enable the methods.

### BACKGROUND

1. Field

Example embodiments relate to a method of cooking food, for example, pizza. Example embodiments also relate to devices which may enable the method of cooking food. In example embodiments the devices may have sloped or inclined surfaces upon which the food is cooked.

2. Description of the Related Art

Pizza is a popular dish worldwide. Pizzas are typically prepared by placing a layer of crust on a flat pizza pan, ladling a sauce on the crust, and then placing, on top of the sauce, other items such as cheese, vegetables, and/or meat. During cooking, grease is often produced from meat and cheese. Because the pizza is generally in a horizontal orientation when cooked, the grease simply remains on or in the pizza. For some consumers, the presence of grease is undesirable. Thus, some consumers turn to using products, such as paper towels or napkins, to blot the pizza to remove the excess grease.

### SUMMARY

The inventor has noted that some foods, for example, pizzas, when cooked, form an excessive amount of grease. Although techniques for manually removing the excessive grease are available (such as paper towels and/or napkins), these methods are generally not economical or efficient. As such, the inventor has sought to develop a new method of cooking a food, for example, pizza, and equipment usable for implementing the method.

In accordance with example embodiments, a method of cooking a pizza may include placing at least a portion of the pizza on at least one inclined surface and cooking the pizza in an oven while the pizza is on the inclined surface.

In accordance with example embodiments, a system for cooking pizza may include a pan having an inclined surface and a receptacle configured to receive grease from the pizza while the pizza is cooked.

### BRIEF DESCRIPTION OF THE DRAWINGS

Example embodiments are described in detail below with reference to the attached drawing figures, wherein:

FIG. 1A is a perspective view of a system in accordance with example embodiments;

FIG. 1B is an exploded-perspective view of the system in accordance with example embodiments;

FIGS. 2A-2B are views of a pan in accordance with example embodiments;

FIGS. 3A-3B are views of a pan in accordance with example embodiments;

FIGS. 4A-4C are views of a support in accordance with example embodiments;

FIG. 5A is a view of a conventional pizza in accordance with example embodiments;

FIG. 5B is a view of a pizza in accordance with example embodiments;

FIG. 6 illustrates a method of cooking a pizza in accordance with example embodiments;

FIG. 7 is a view of a system in accordance with example embodiments;

FIGS. 8A and 8B are views of a pan in accordance with example embodiments;

FIGS. 9A-9B are views of cooking a pizza using a pan in accordance with example embodiments;

FIGS. 10A-10C are views of a system in accordance with example embodiments;

FIGS. 11A-11B are close-up views of a portion of a system for cooking a food in accordance with example embodiments;

FIGS. 12A-12B are close-up views of a portion of a system for cooking a food in accordance with example embodiments;

FIGS. 13A-13B are views of a method of cooking a pizza in accordance with example embodiments; and

FIGS. 14A-14C illustrate a system in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a method of cooking food, for example, pizza. Example embodiments also relate to devices which may enable the method of cooking food. In example embodiments the devices may have sloped or inclined surfaces upon which the food is cooked.

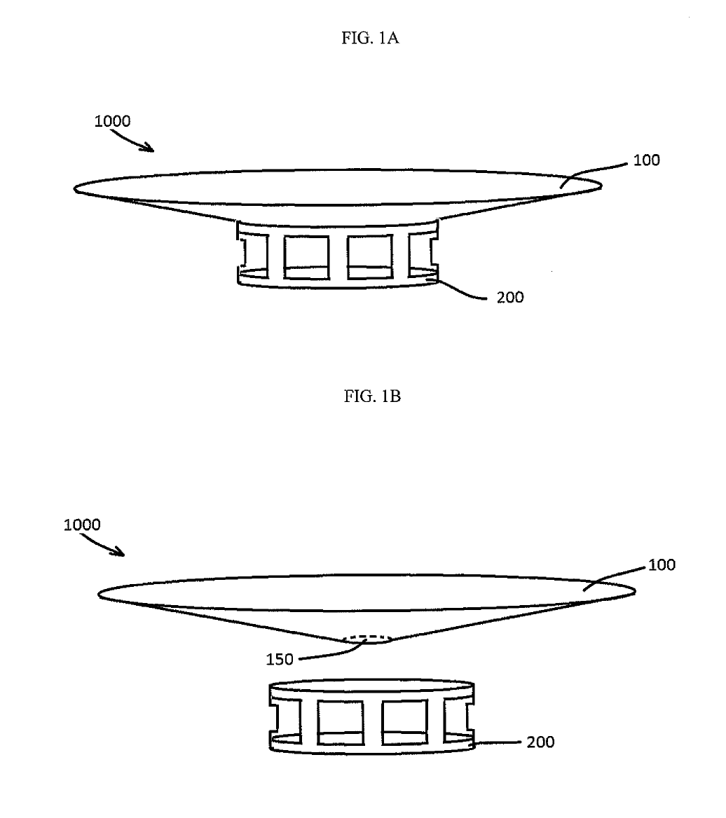

FIG. 1A illustrates a system 1000 usable for cooking a food item, for example, pizza. FIG. 1B is an exploded view of the system 1000. As shown in FIGS. 1A and 1B, the system 1000 may include a pan 100 and a support 200.

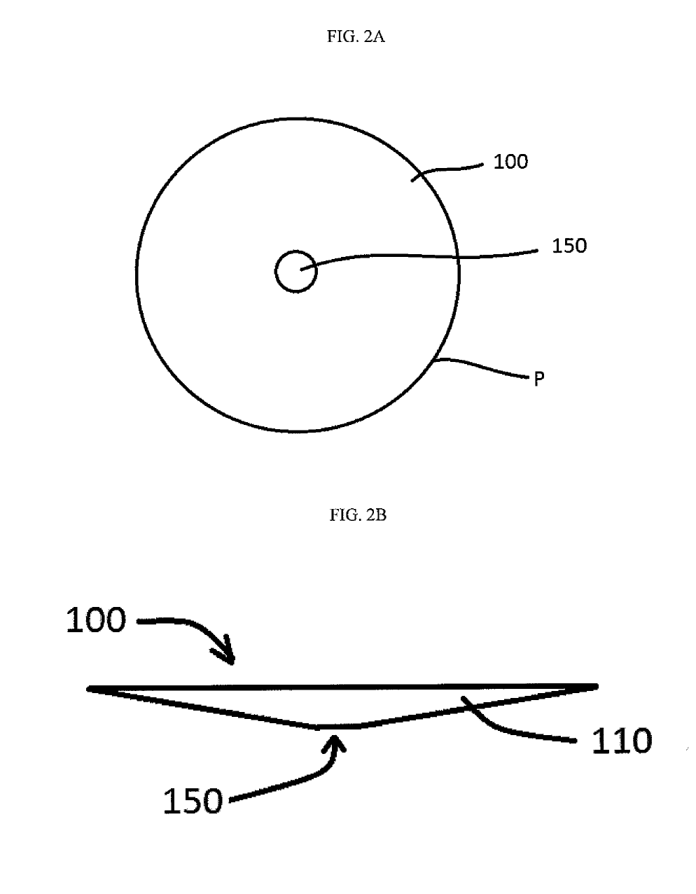

FIGS. 2A and 2B illustrate a top view and a side view of the pan 100 in accordance with example embodiments. As shown in FIGS. 2A and 2B, the pan 100 may have an outer perimeter P and a hole 150 formed at or near a middle thereof. Between the outer perimeter P and the hole 150 is a sloped or inclined surface 110. In example embodiments the perimeter P may be circular and the hole 150 may also be circular. This, however, is not meant to be a limiting feature of the invention as the perimeter P and/or the hole 150 may have another shape, such as a polygonal or irregular shape. For example, the perimeter P may actually be in the shape of a rectangle and the hole may also be in the shape of a rectangle. In this latter embodiment the pan 100 may resemble a truncated pyramid. In the event the perimeter P is a circle, the sloped or inclined surface 110 may have a substantially conical shape. Thus, when the perimeter P is a circle, and the hole 150 is a circular hole, the sloped or inclined surface 110 may resemble a funnel. Example embodiments are not intended to be limited to pans which resemble a funnel or a truncated pyramid, however, an important aspect of example embodiments is that the pan have sloped and/or inclined surfaces. In this application, a sloped and/or inclined surface is one which is not purely horizontal with respect to the ground.

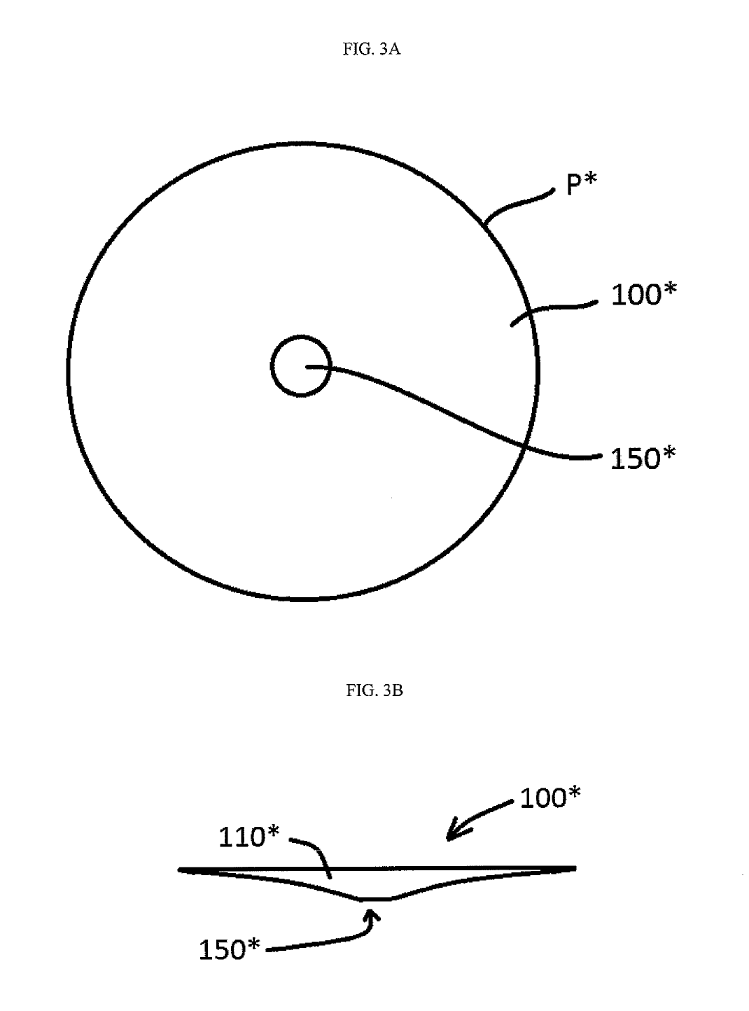

In example embodiments, a slope of the sloped or inclined surface 110 may be substantially constant, however, example embodiments are not limited thereto. For example, FIGS. 3A and 3B represent another example of a pan 100* in accordance with example embodiments. In FIGS. 3A and 3B the pan 100* may have an inclined surface 110* with a varying slope. For example, in example embodiments the inclined surface 110* may have an arcuate shape, an elliptical shape, and/or a parabolic shape. However, like pan 100, pan 100* may also include a hole 150* near a middle thereof. In example embodiments, the pan 100 and 100* may be substantially interchangeable with one another in the system 1000.

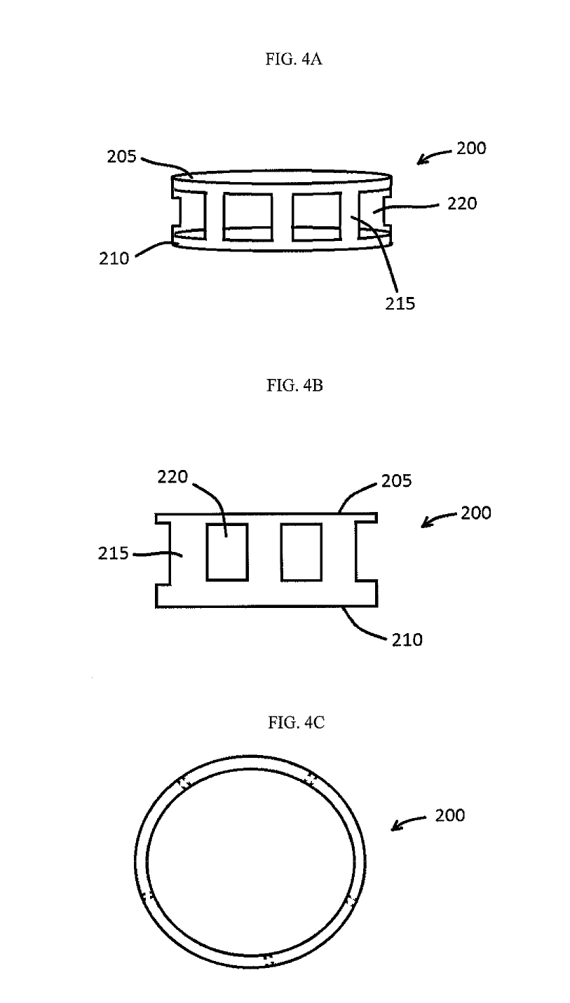

FIGS. 4A-4C illustrate a perspective view of the support 200, a side view of the support 200, and a top view of the support 200. As shown in FIGS. 4A-4C, the support 200 may resemble a cylinder having an open top 205 and a closed bottom 210. The support 200 may also have sides 215 with apertures 220 formed therein. Although the figures illustrate the support 200 as including sides 215 with apertures 220, the invention is not limited thereto as the sides 215 may not include apertures or may include only a single aperture. Furthermore, although the sides 215 are illustrated as being cylindrical, this is also not intended to be a limiting feature of the invention as the sides 215 may form another shape. For example, the sides 215 may be flat and may form a polygonal pattern (for example, a rectangle) when viewed from the top or some other shape such as, but not limited to, an ellipse.

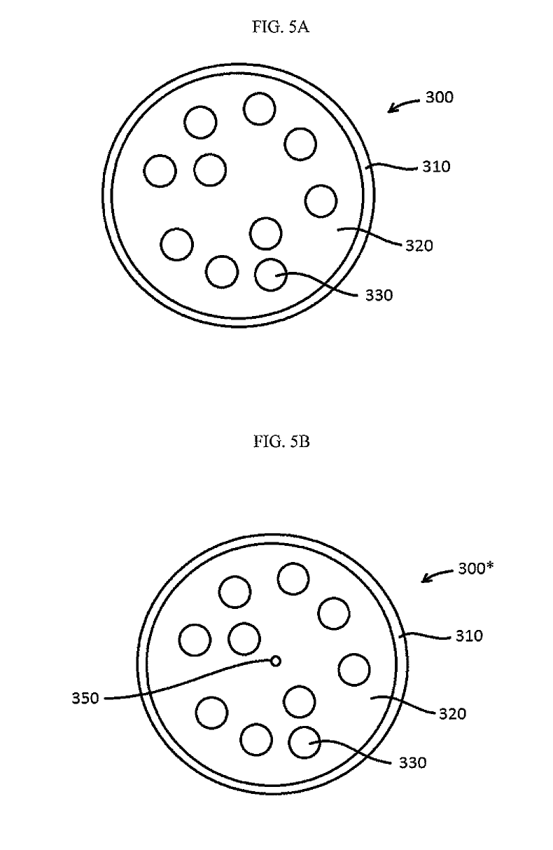

FIG. 5A is a view of a pizza 300 in accordance with the conventional art. As shown in FIG. 5A, the pizza 300 typically includes an outer crust 310, an area covered by sauce and cheese 320, and a topping 330 which may be a meat such as, but not limited to, pepperoni, hamburger, and/or sausage. In the conventional art pizzas are typically cooked on a substantially flat and horizontal plate. As explained above, in the conventional cooking process, the ingredients in the pizza often produce a grease which remains on top of the pizza while it cooks. The presence of such grease, for many consumers, is often undesirable.

FIG. 5B is a view of a pizza 300* in accordance with example embodiments. As shown in FIG. 5B the pizza 300* may be substantially the same as the conventional pizza 300, except that pizza 300* includes a hole 350 near a middle thereof. In example embodiments, the hole 350 may be created by simply cutting a hole out of a conventional pizza 300 or forming the pizza 300* with a hole.

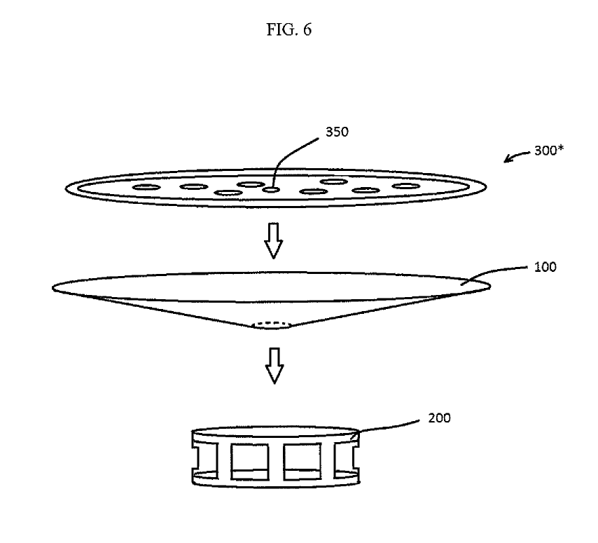

FIG. 6 illustrates a method of cooking the pizza 300* using the system 1000 in accordance with example embodiments. In example embodiments, the pizza 300* may be placed in the pan 100 (or 100*) such that the hole 150 (or 150*) of the pan 100 (or 100*) and the hole 350 of the pizza 300* are substantially aligned. The pan 100 with the pizza 300* thereon may be placed on the base 200 and the pan 100 (or 100*), the base 200, and the pizza 300* may be placed in an oven. In example embodiments, because the pizza 300* is supported on the inclined surface 110 (or 110*) the pizza 300*, as supported by pan 100, will also have an inclined shape. During cooking, grease generated by the pizza 300* will flow, under gravity, along a top of the pizza 300* to the hole 350 where it drains into the support 200 via the hole 150 (or 150*) of the pan 100 (or 100*). Because the support 200 includes a closed bottom 210, the grease may be captured by the base 200. The result is a pizza with reduced grease since the grease which normally cooks and remains on top of the pizza 300 is drained therefrom due to gravity and the inclined surface 110 (or 110*) of the pan 100 (or 100*).

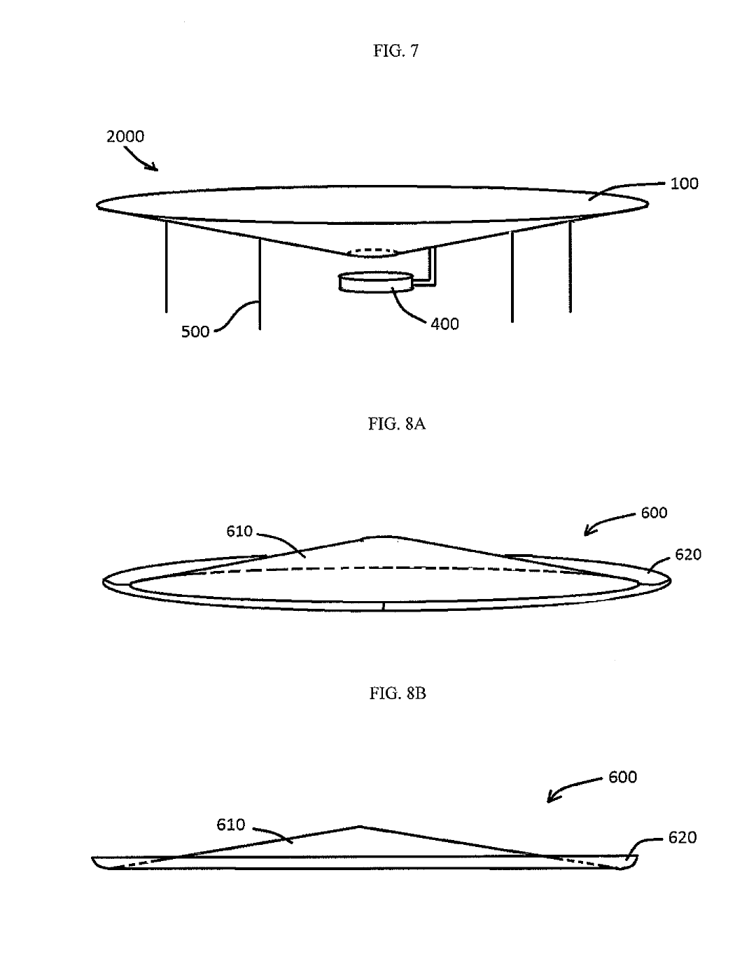

FIG. 7 is another view of a system 2000 in accordance with example embodiments. In FIG. 7 the system 2000 may include the pan 100 (or 100*) and a cup 400. In example embodiments the cup 400 may be placed below the hole 150 (or 150*) which may be in the pan 100 (or 100*). The cup 400, like support 200, may serve as a receptacle to catch grease which may be formed during a cooking operation, for example, when pizza 300* is cooked on pan 100 (or 100*). In example embodiments, the cup 400 may be detachably coupled to the pan 100 (or 100*) so that the cup 400 may be detached for emptying and/or ease of cleaning. For example, in example embodiments, the cup 400 may be attached to the pan 100 via screws or clips. In example embodiments, the system 2000 may further include supports 500 to support the pan 100 (or 100*) during a cooking operation. The supports 500, for example, may resemble pegs, rods, or even plates. The system 2000, however, does not necessarily require supports 500. For example, the pan 100 with the cup 400 attached thereto may simply be placed in the support 200, or a similar structure. In this latter embodiment the grease would be caught by the cup 400 rather than the support 200.

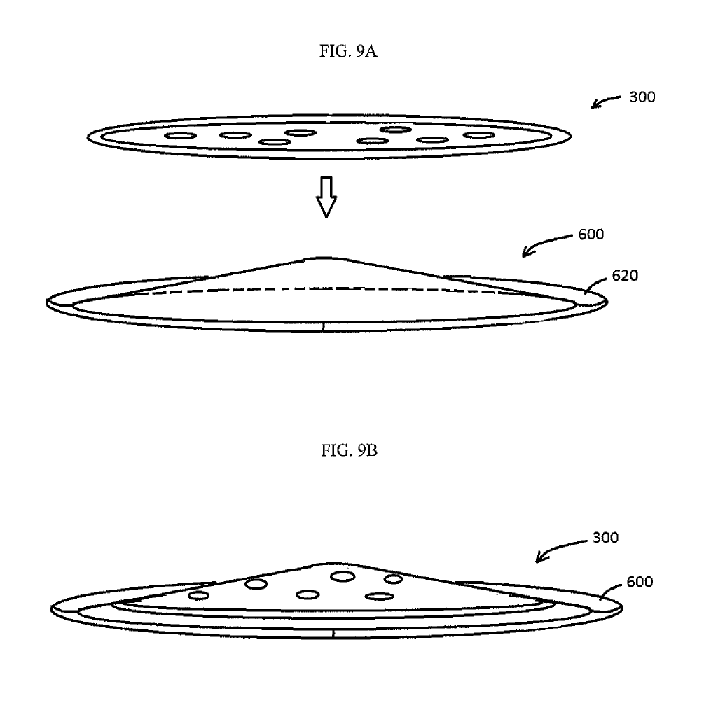

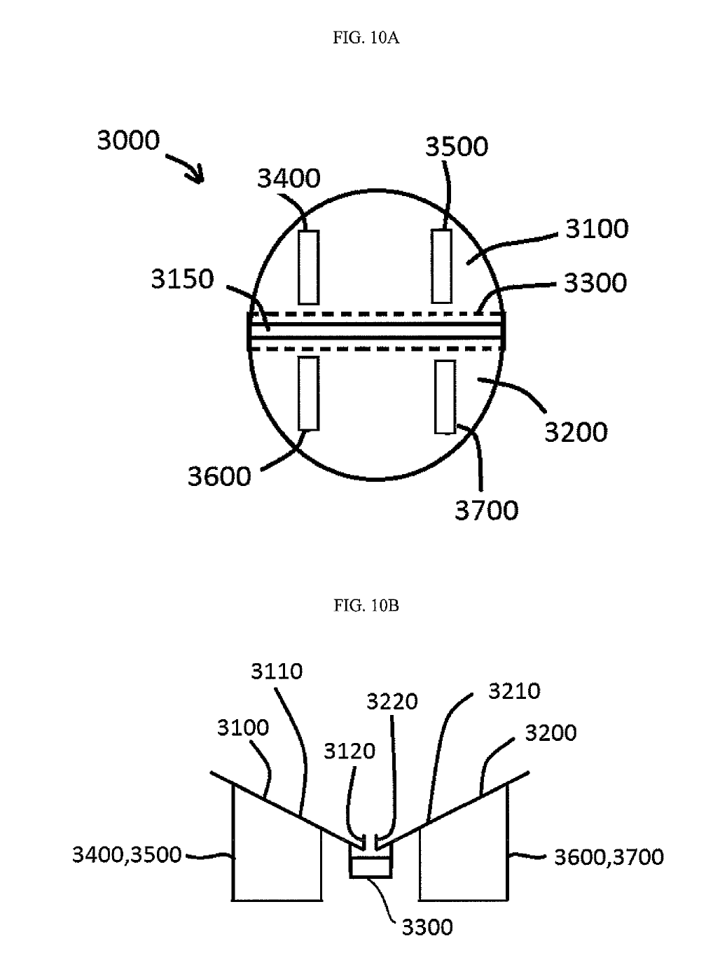

FIGS. 8A and 8B illustrate a pan 600 in accordance with example embodiments. In Example embodiments the pan 600 may resemble an inverted cone having an inclined surface 610 surrounded by a lip 620 which may serve as a grease receptacle. In example embodiments a pizza 300 or 300* may be placed on the pan 600 and cooked while on the pan 600. For example, as shown in FIGS. 9A and 9B, a conventional pizza 300 may be placed on pan 600 and the pan 600 with the pizza 300 thereon may be placed in an oven for cooking. In this particular nonlimiting example embodiment, any grease formed therefrom would flow across a top of the pizza 300 or 300* and into the lip 620. The result would be a pizza with reduced grease when compared to conventionally cooked pizzas.

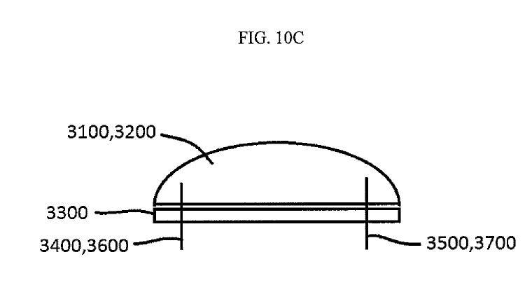

FIGS. 10A-10C illustrate a system 3000 which may enable a method of cooking a food in accordance with example embodiments. As shown in FIGS. 10A-10C the system 3000 may include a first member 3100 and a second member 3200 separated by a gap 3150. In example embodiments the first member 3100 may include a first section 3110 and a second section 3120. The first section 3110 may resemble a semicircular plate, for example, one half of a conventional pizza pan. The second section 3120, on the other hand, may resemble a thin plate configured to act as a stop for when a food item, for example, pizza, is placed on the first section 3110.

The second member 3200 may resemble the first member 3100. For example, the second member 3200 may include a first section 3210 and a second section 3220. The first section 3210 may resemble a semicircular plate, for example, one half of a conventional pizza pan. The second section 3220, on the other hand, may resemble a thin plate configured to act as a stop for when a food item, for example, pizza, is placed on the first section 3210.

In example embodiments the first member 3100 may be supported by support elements. For example, the first member 3100 may include a first support member 3400 and a second support member 3500. Each of the first and second support members 3400 and 3500 may resemble a trapezoidal plate which may be rigidly attached to the first member 3100. Similarly, the second member 3200 may be supported by support members. For example, the second member 3200 may include a first support member 3600 and a second support member 3700. Each of the first and second support members 3600 and 3700 may resemble a trapezoidal plate which may be rigidly attached to the second member 3200. The particular type of support members are not intended to limit the invention since the support members may be embodied in various forms including, but not limited to, posts, rods, or blocks and may or may not be rigidly attached to the first and second members 3100 and 3200.

In example embodiments, the first and second members 3100 and 3200 may be arranged adjacent one another to form the gap 3150. Beneath the gap 3150 is a tray 3300 which may include an open top to receive grease and a body to store the received grease. As such, the tray 3300 may act as a receptacle into which the grease may be collected. In example embodiments the tray 3300 may be attached to, and supported by, each of the first and second member 3100 and 3200 or to one of the first and second members 3100 and 3200. In the alternative, the tray 3300 may be independently supported.

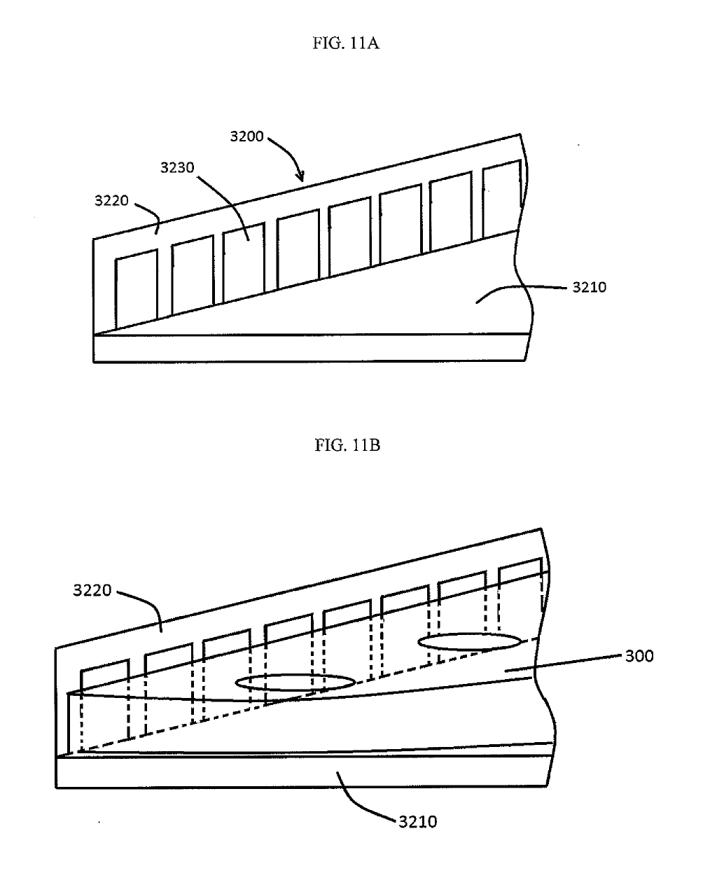

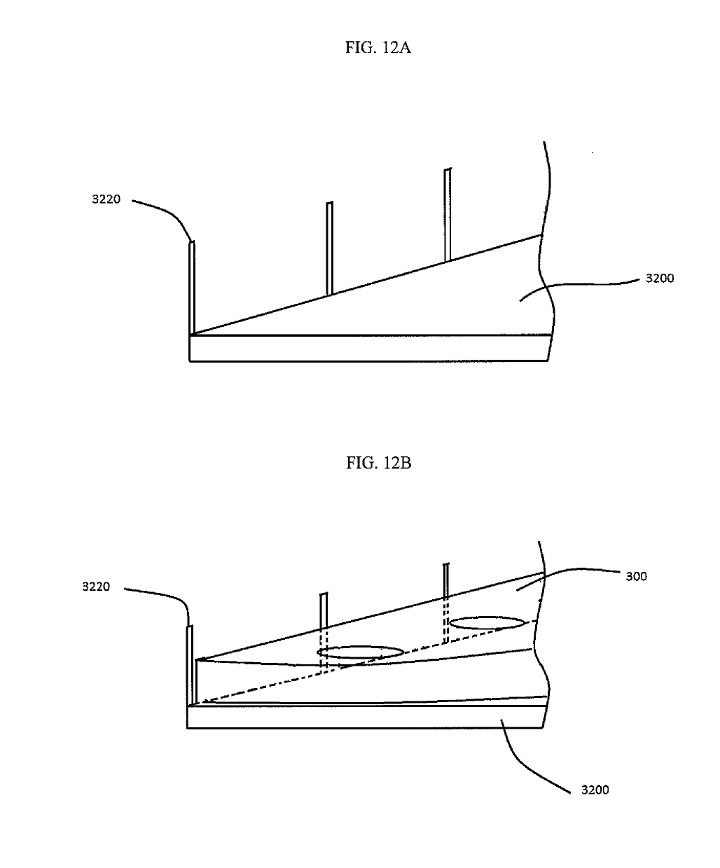

FIGS. 11A and B illustrate a close up of the first and second sections 3210 and 3220 of the second member 3200. As shown in FIG. 11A, the second section 3220 may resemble a relatively thin plate with perforations 3230. The perforations 3230 may allow grease to flow through the second section 3220 and into the tray 3300. For example, as shown in FIG. 11B, when a food item, for example, pizza 300 is placed on the first section 3210 of the second member 3200, an end of the pizza 300 may be close to, or bear up against, the second section 3220. Because the second section 3220 is perforated, any grease formed on the pizza may flow across a top of the pizza and through the second section 3220. It is understood that example embodiments are not limited by the instant example. For example, in example embodiments, rather than having a second section 3220 which resembles a plate, the second section 3220 may simply be comprised of a plurality of stops 3240 as shown in FIGS. 12A and 12B. The stops 3240 may, for example, resemble rod like members which prevent a food item, for example, pizza, from slipping off of the first section 3210. For example, as shown in FIG. 12B, when a pizza 300 is placed on the first section 3210 of the second member 3200 the stops 3240 prevent the pizza 300 from sliding off of the first section 3210 and yet allow grease to flow from across a top of the pizza and into the tray 3300.

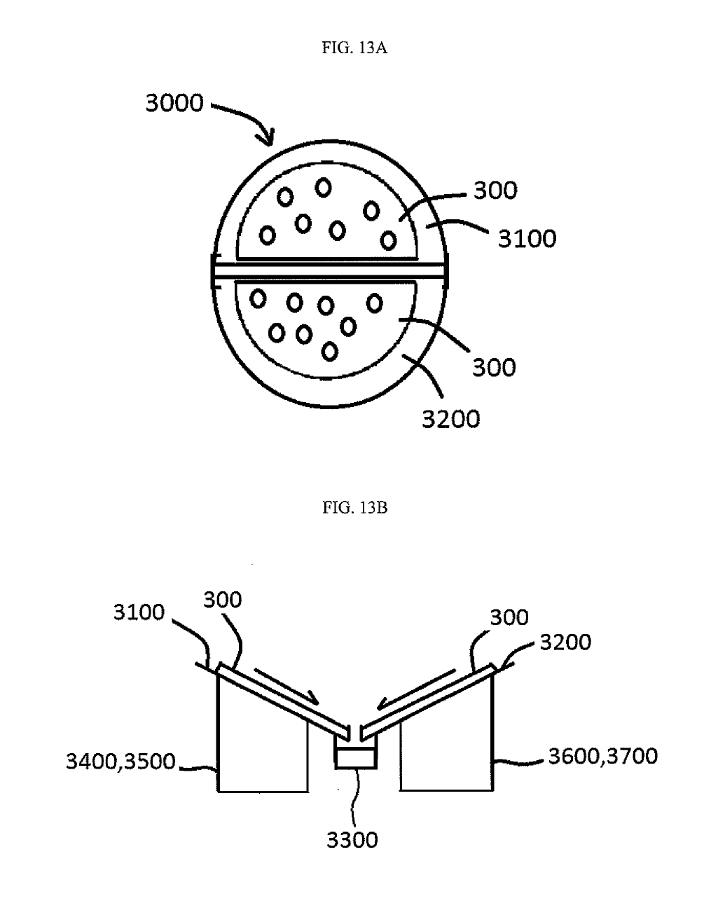

FIGS. 13A and 13B illustrate a pizza 300 being cooked using the system 3000 in accordance with example embodiments. As shown in FIGS. 13A and 13B the pizza 300 may be cut into two halves with one half being placed on the first section 3110 of the first member 3100 and the other half being placed on the first section 3210 of the second member 3200. Because each of the first sections 3110 and 3210 are inclined, the pizza 300 supported therein is also inclined. As such, as the pizza 300 is cooked grease generated by the pizza will flow along the top of the pizza 300 (as indicated by the arrows in FIG. 13B), through the second sections 3120 and 3220 of the first and second members 3100 and 3200 and into the tray 3300. As such, the system 3000 is capable of producing a food product, for example, pizza, which has reduced grease when compared to the conventional art.

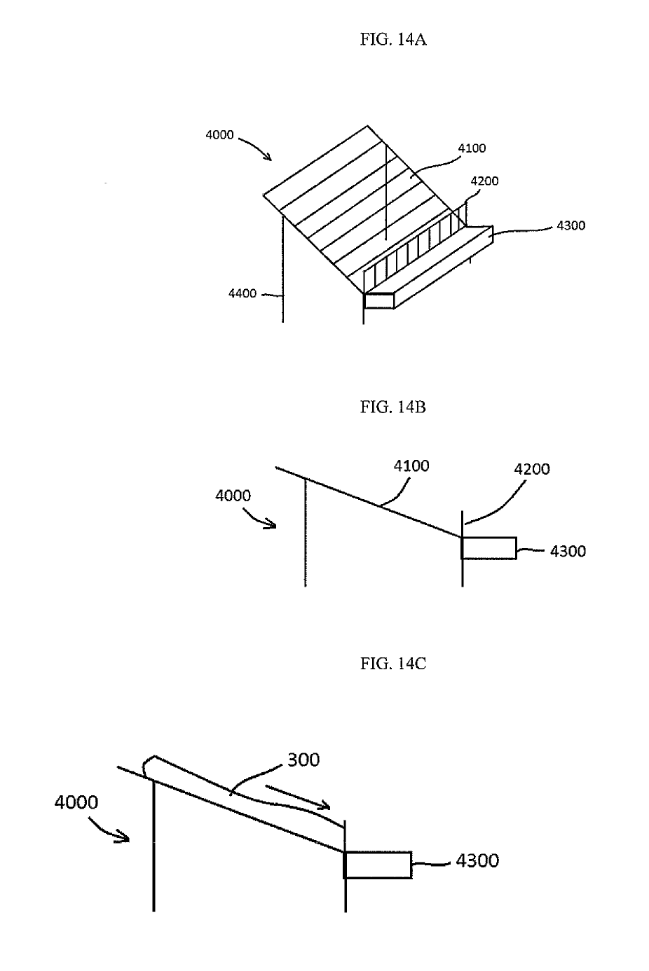

In example embodiments the inclined surfaces 110, 110*, 610, and 3110, and 3210 may resemble relatively thin plates with continuous surfaces, however, this is not intended to be a limiting feature of example embodiments. For example, rather than having continuous surfaces, the inclined surfaces 110, 110*, 610, and 3110, and 3210 may or may not have perforations and/or channels formed therein. In addition, rather than resembling plates, the inclined surfaces may be constructed from multiple members which may resemble a grill. For example, FIG. 14A is a view of another system 4000 which may be used to enable a method of cooking a food, for example, pizza. In FIG. 14A, an inclined surface 4100 is constructed from several bars and thus may resemble a grill. The inclined surface 4100 may have a stop 4200 at one end thereof comprised of a plurality of bars which form perforations. The system 4000 may further include support legs 4400 to support the inclined surface 4100. In example embodiments a grease tray 4300 (another example of a receptacle) may be arranged near the stop 4200. The grease tray 4300 may be configured to catch grease that may be formed on food that may be cooked on the inclined surface 4100. For example, FIG. 14C illustrates the system 4000 with half a pizza 300 on the inclined surface 4100. As the pizza 300 is cooked grease therefrom may flow across a top of the pizza and into the grease tray 4300 as shown in FIG. 14C where the arrow indicates a flow of grease across a top of the pizza 300. In view of the above, it is clear that inclined surfaces of example embodiments are nonhorizontal surfaces which are configured to support a majority of the weight of a food item, for example, pizza, while the food item is cooked, and which may be either substantially continuous or substantially discontinuous as in FIGS. 14A-14C.

While example embodiments have been particularly shown and described with reference to example embodiments thereof, it will be understood by those of ordinary skill in the art that various changes in form and details may be made therein without departing from the spirit and scope of the invention.

What we claim is:

1. A method of cooking a pizza, the method comprising:
placing at least a portion of the pizza on at least one inclined surface; and
cooking the pizza in an oven while the pizza is on the inclined surface.

2. The method of claim 1, further comprising:
forming a hole in a middle of the pizza.

3. The method of claim 2, further comprising:
arranging the pizza on the inclined surface so that the hole in the middle of the pizza is aligned with a hole in the inclined surface.

4. The method of claim 3, further comprising:
collecting grease from the pizza in a receptacle while the pizza is cooked.

5. The method of claim 4, wherein the receptacle is one of a cup, a tray, and a support.

6. The method of claim 1, further comprising:
cutting the pizza in half and placing one half of the pizza on the inclined surface.

7. The method of claim 6, further comprising:
collecting grease from the one half of pizza in a receptacle while the one half a pizza is cooked.

8. A system for cooking pizza, the system comprised of:
a pan having an inclined surface; and
a receptacle configured to receive grease from the pizza while the pizza is cooked.

9. The system according to claim 8, wherein the pan has a circular perimeter.

10. The system according to claim 8, wherein the inclined surface has one of a constant slope and a varying slope.

11. The system according to claim 8, wherein the container is one of a support having a closed bottom, a tray, and a cup.

12. The system according to claim 8, wherein the inclined surface has a hole arranged near a middle thereof.

13. The system according to claim 12, wherein the receptacle is configured to receive grease via the hole.

14. The system according to claim 8, wherein the receptacle is arranged at a side of the inclined surface.

15. The system according to claim 14, wherein the inclined surface has a section with a plurality of apertures and the receptacle receives the grease via the plurality of apertures.
